(19) United States
(12) Patent Application Publication
(10) Pub. No.: US 2003/0138188 A1
(43) Pub. Date: Jul. 24, 2003

(54) Standoffs for passive alignment of semiconductor chip and coupling bench

(76) Inventors: Hwi Siong Lim, Singapore (SG); Cher Liang Randall Cha, Singapore (SG); Yee Loy Lam, Singapore (SG); Kian Hin Victor Teo, Singapore (SG)

Correspondence Address: BUCKLEY, MASCHOFF, TALWALKAR, & ALLISON, 5 ELM STREET, NEW CANAAN, CT, 06840, US

(21) Appl. No.: 10/304,882

(22) Filed: Nov. 26, 2002

(30) Foreign Application Priority Data
Nov. 29, 2001 (GB) 0128616.0

(51) Int. Cl. G02B 6/12

(52) U.S. Cl. 385/14

(57) ABSTRACT

Disclosed is a method for forming a first optical device and a vertical stand-off on adjacent regions of a substrate. The method comprises the steps of: depositing subsequent layers of optical materials on the substrate and defining features of the optical device by masking and etching regions of at least one layer; defining the transverse extent of the stand-off by protectively masking a separate region of the or each layer that is etched; modifying the relative thickness of an upper section of the stand-off and the first optical device so that a second optical device subsequently supported by the stand-off is in close optical alignment with the first optical device; and etching a trench through one or more layers of material between the vertical stand-off and the first optical device.

Also disclosed is an optical assembly comprising a first optical device and at least one vertical stand-off formed on adjacent regions of a substrate.

### INTRODUCTION

The present invention relates to the alignment of a light emitting chip with a waveguide structure. In particular, the invention relates to the provision of standoffs or spacers for the passive alignment of semiconductor laser chips with (optical fibre) coupling benches.

It is estimated that packaging and testing may account for 90% of the cost of a semiconductor laser. The major part of this is related to the fibre-chip alignment, which in a conventional device needs to be carried out actively, i.e., with the laser emitting light, the fibre is moved to maximise the light collected before being fixed usually by a high precision laser weld. The stability required from this fixing is to a sub-micron tolerance over a wide temperature range for the whole lifetime of the component. The reason for this tight tolerance is a result of the incompatibility in terms of optical waveguiding between standard low loss single mode silica fibre and conventional edge emitting III-V semiconductor lasers. The very small refractive index difference (Δn<5×10⁻³) between core and cladding in the fibre results in a weakly guided optical mode with a typical mode size of 8-10 μm and acceptance angle ˜7°. In a typical semiconductor laser, the optimisation of electronic and optical confinement in the design of the semiconductor layer structure, leads generally to Δn greater than 10⁻², resulting in mode sizes of 1 μm or less and emission angles of >30°. Moreover, the mode is generally not circularly symmetric. If different mode sizes are simply coupled together, it is impossible to achieve a high coupling efficiency. Therefore, a mode size converter or spot size converter (both referred to herein as SSC) is sometimes built, and sandwiched between the semiconductor laser and fibre, on a same platform, for example a coupling bench, to couple light effectively between the two entities.

In cases there the chip is flip-bonded to a coupling bench (P-side bonding), stand-offs (spacers) are needed both to support the chip and to provide vertical alignment to a waveguide in SSC. Conventional practice sees polyimide stand-offs being built on P-side of chip. The polyimide stand-offs, upon inversion, will have their opposite faces in contact with the coupling bench. The contraction volume of solder bumps, and the height of the polyimide stand-offs have to be pre-determined to cater for best vertical alignment between chip and SSC. Inconsistency of chip alignment to SSC often arises owing to these process-dependent variables.

In accordance with the present invention, there is provided an optical assembly comprising a first optical device and at least one vertical stand-off formed on adjacent legions of a substrate, the or each vertical stand-off and a portion or the first optical device comprising a common planar multiple-layer structure the relative thickness of an upper section of the first optical device and the or each vertical stand-off being such that a second separate optical device subsequently located on the or each stand-off is brought in close optical alignment with the first optical device.

Advantageously the stand-offs are separated from the first optical device by a trench.

The first optical device may comprise one or more planar lightwave circuits (PLC). The first optical device may be a spot size converter.

Preferably, the substrate comprises a material selected from a group including silicon, silica-on-silicon, silicon-on-insulator, III-V semiconductor and ceramics.

Conveniently, the assembly further comprising a second optical device located on the or each stand-off and in close optical alignment with the first optical device. The second optical device may be keyed for engagement with the or each vertical stand-off. Alternatively, or additionally, the second optical device may be a semiconductor laser.

An optical assembly in accordance with the present invention may be formed from a plurality of optical devices and a plurality of adjacent vertical stand-offs formed on a common substrate.

In accordance with another aspect of the present invention, there is provided a method for forming a first optical device and a vertical stand-off on adjacent regions of a substrate, comprising the steps: depositing subsequent layers of optical materials on the substrate, and defining features of the optical device by masking and etching regions of at least one layer; defining the transverse extent of the standoff by protectively masking a separate region of the or each layer that is etched; modifying the relative thickness of an upper section of the standoff and the first optical device so that a second optical device subsequently supported by the standoff is in close optical alignment with the first optical device; and etching a trench through one or more layers of material between the vertical standoff and the first optical device.

The step of modifying the relative thickness of an upper section of the standoff and the first optical device may comprise recess etching an upper layer in the region that defines the standoff.

Alternatively, the step of modifying the relative thickness of an upper section of the standoff and the first optical device may comprise recess etching an upper layer in the region that defines the optical device.

In either case, the step of modifying the relative thickness may further comprise depositing an additional layer of material over regions defining both the vertical standoff and the first optical device.

### BRIEF DESCRIPTION OF THE DRAWINGS

FIGS. 1A and 1B show the process of fabricating the standoffs for precise height alignment in accordance with the present invention;

FIG. 2 illustrates how the recess etch depth is determined; and

FIG. 3 shows stages of an alternative process for fabricating standoffs in accordance with the present invention.

### DETAILED DESCRIPTION

In the present invention the standoffs are built at the same time as the SSC stack. Unlike polyimide standoffs, these SSC stand-offs do not subside under solder bump contraction, thus ensuring constant height regardless of variation in solder bump contraction. Furthermore, it allows us the versatility to perform specific recess etching to cater for exact alignment of laser waveguide core in semiconductor chip to the centre of the first layer of the planar lightwave circuit (PLC1). The process is also simpler as compared to the one with polyimide standoffs.

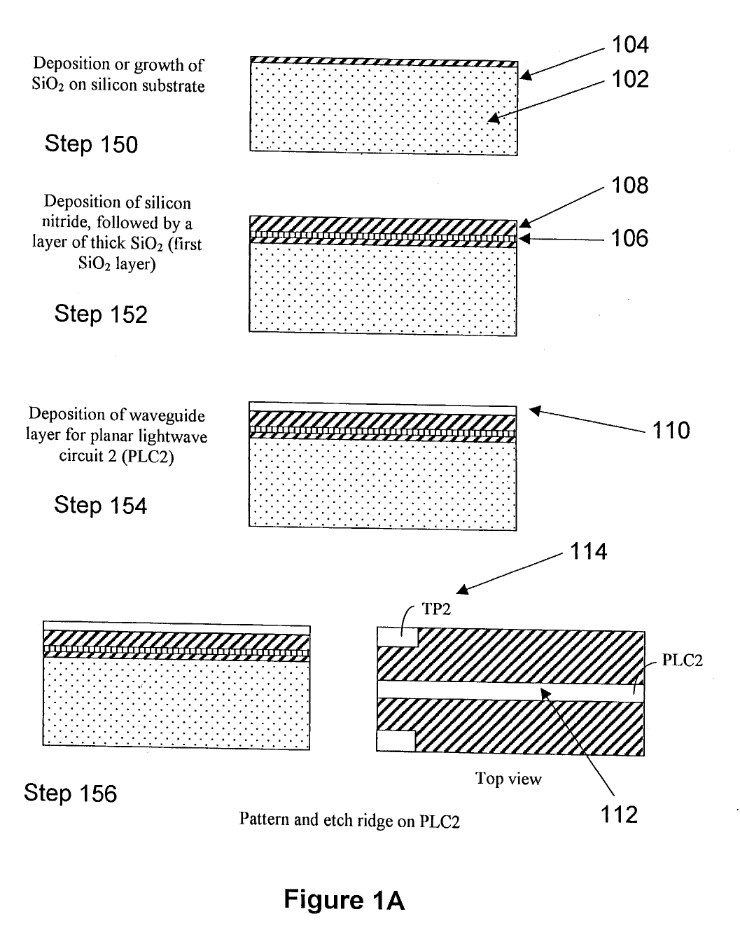

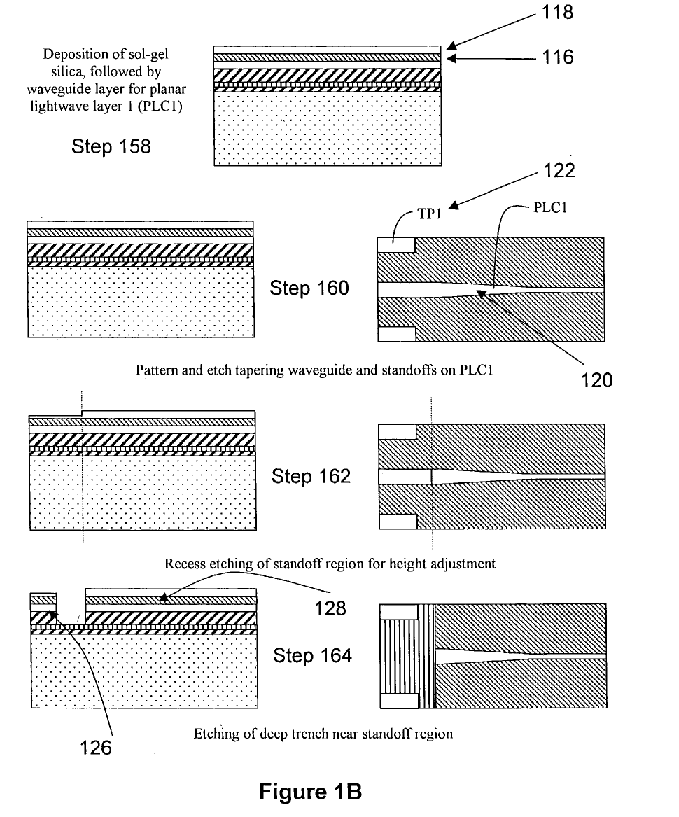

The process of fabricating the standoffs for precise height alignment is shown in FIGS. 1A and 1B, whereby we adopt silicon as the starting material 102 for the coupling bench. Other substrates such as silica-on-silicon, silicon-on-insulator, III-V semiconductors, ceramics etc. are also applicable.

A layer of silicon dioxide (SiO₂) 104 is either thermally grown (10 nm-5 nm), chemically vapor deposited (APCVD, LPCVD, PECVD), liquid phase deposited or jet evaporated (Step 150). Provided on top of the silicon dioxide layer 104 is a layer OT silicon nitride (Si₃N₄) 106, which usually has a thickness that is approximately 9 to 12 times the thickness of the underlying silicon dioxide layer. The silicon nitride/oxide stack 104, 106 serves as an etch-stop layer upon completion of stack etch (wet or dry etching) of the SSC and SSC stand-offs. In addition, if we are plating bumps on the coupling bench, this composite stack affords the wanted electrical isolation, since silicon is semi-conducting. Nevertheless, if we employ a silicon substrate, which has a very high resistivity, the insulating base may be redundant.

A first layer of silica or PECVD SiO₂ 108 is deposited, preferably >5 μm thick, to avoid substrate leakage (light loss) and a uniform refractive index, η_{silica} (Step 152). Next, a second layer of PECVD SiO₂ 110 is deposited over the first PECVD SiO₂ layer 108 (Step 154). The second SiO₂ layer 110 will subsequently be masked and patterned via wet/dry etch into two regions (Step 156):

a pattern symbolizing a planar lightwave circuit (PLC2) 112, and

several SSC standoff thumb pads (TP2) 114 (the number of standoffs being dependent on dimensions of flip chip and coupling bench 102).

The second SiO₂ layer 110 also registers a refractive index, η_{PLC 2}, which should be higher than the refractive index for the first SiO₂ layer 108. Usually, their respective refractive indexes have to be tailored according to the demands on SSC. An example of the values will be the η_{silica}=1.46 and N_{PLC 2}=1.475. The second SiO₂ layer 110 can be substituted by either a SiON layer or Si₃N₄ layer, if preferred, but those substitute materials require the implementation of a slightly different known process flow (not described here).

In the pictorial process flow of FIGS. 1A and 1B, a sol-gel silica 116 is later spun over the defined PLC2 112 and TP2 114. The amount of sol-gel is usually spun on in consecutive steps until the PLC2 112 and TP2 114 are fully submerged. The sol-gel layer 116, owing to the revolutions and centrifugal strength, presented a planar layer above the PLC2 112. It is important to have a planar sol-gel surface since we need to perform additional photolithographic patterning over it (which will be discussed in soon time). It is also important to have the refractive index of sol-gel similar in value to that of first SiO₂ layer 108, i.e., η_{sol-gel}=n_{silica}. The sol-gel layer 116 can also be substituted by a third PECVD SiO₂ layer. However, an additional mask (reverse masking) would typically be needed for dry etch-back of a third PECVD SiO₂ layer (i.e. for planarization), which will show step heights at locations whereby the PLC2 112 and TP2 114 are located.

A layer of SiON (silicon oxynitride) 118 is then deposited over the planar sol gel surface 116. Just like the second SiO₂ layer 110, the SiON 118 is also masked and etched out to form two regions (Step 160):

a planar lightwave circuit (PLC 1) 120, and

the SSC standoff thumb pads (TP1) 122.

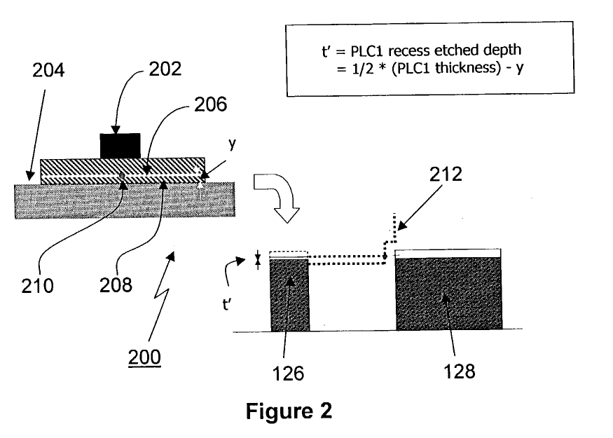

The PLC1 120 overlaps with the PLC2 112, while the SSC standoff thumb pads TP1 122 overlap with the SSC thumb pads TP2 114 underneath. Followings that, the patterned PLC1 120 and TP1 122 are masked for a second time to perform recess etching (Step 162). This is usually accomplished by dry etching for precise etched depth control. The exposed PLC1 120 and TP1 122 are thinned down by a thickness, t′. The magnitude of t′ is dependent on the location of laser quantum wells in the semiconductor chip, and discussed in more detail in relation to FIG. 2.

After recessing etching, the PLC1 120 and the TP1 122 are masked for the third time (Step 164) and so that the actual SSC stack etch and the SSC standoff stack etch can be performed. Eventually, only the SSC stack 128 and the SSC standoffs 126 will remain standing on the coupling bench after the dry etch. We can then proceed on with our metallization and metal/solder bumping for the subsequent flip chip bonding.

By building SSC standoffs 126, we actually enhanced the alignment accuracy of laser spot to the center of the PLC1 waveguide 120. Such improvement in chip-waveguide alignment accuracy is definitely not obtainable from polyimide standoffs, which readily subside to solder bump contraction/expansion. The etching is of such tall polyimide standoffs is also tedious, and the etch time has to be constantly tuned or modified owing to the frequent non-uniform film thickness of spun-on polyimide. In addition, the long etch times introduce plasma process-induced damages (electrons & ions shadowing, and radiation damages) Furthermore, the polyimide standoffs can ‘shrink’ at high temperatures (>400° C.)—using them as standoffs for chip alignment will be highly unreliable.

FIG. 2 illustrates how the required PLC1 recess etched depth, t′, is determined. A laser chip 200 is manufactured as a ridge 202 disposed upon a cladded quantum well (QW) stack 206. The vertical separation between the base of the lower cladding layer 208 and the QW region 210 in the stack is denoted “y”. The PLC1 recess etch depth, t′, should be such that the QW region 210 aligns with the PLC1. Assuming that the best alignment will be achieved at the centre of the PLC1 (hallway through the thickness of the PLC1 layer), t′ is calculated as the difference between half the thickness of the PLC1 and the distance y:

t′=½*(PLC1 thickness)−y

Once assembled, the laser chip 200 is disposed (flip-bonded) with the ridge 202 lowermost in the recess etched portion of the converter stack. The dashed line 212 illustrates where the laser chip lies relative to the standoffs 126 and the stack 128. Pockets 204 are provided at either side of the ridge 202 to engage with the converter standoffs 126.

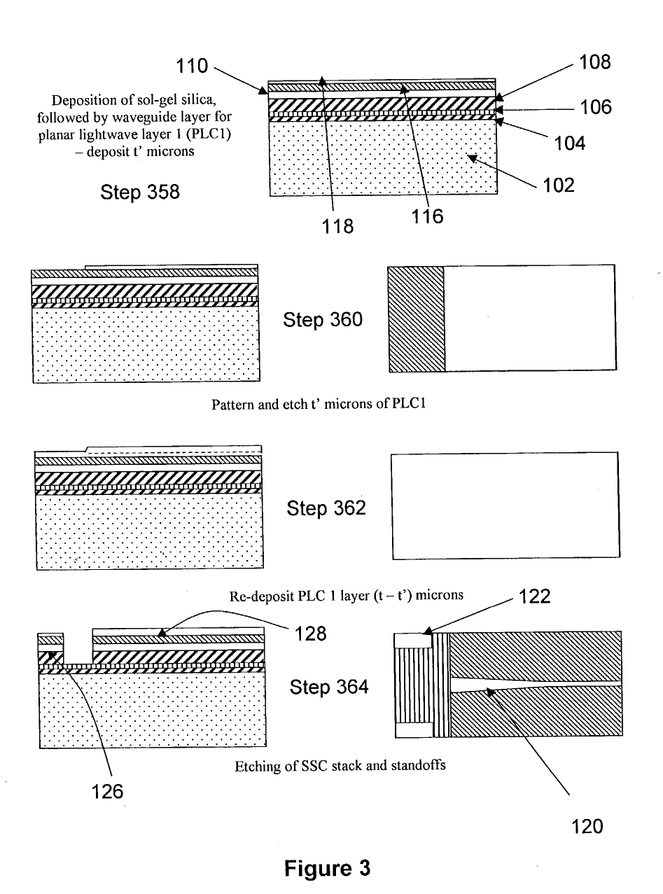

As an alternative to the steps shown in FIG. 1B, the same recess etched SSC standoffs 126 and stack 128 can be constructed in another manner. FIG. 3 illustrates this alternative process flow. This process flow only differs from the steps in FIG. 1B in the manner of PLC1 layer 118 deposition. In the alternative process flow, the PLC1 layer 118 is deposited in two stages. The required PLC1 120 thickness is t micron.

In the first deposition stage (Step 358), the PLC1 layer 118 is deposited to a thickness of t′ microns. A portion of the PLC1 layer 118, where the SSC stack 128 is to be built, is masked. The remaining, exposed areas of the PLC1 layer 118 are etched (Step 360).

In the second deposition stage (Stop 362), a further (t−t′) microns of the PLC1 layer is deposited in this way, the SSC stack 128 still has the full height (t) while the SSC standoffs 126 have a height that is t′ microns shorter.

1. An optical assembly comprising a first optical device and at least one vertical stand-off formed on adjacent regions of a substrate, the or each vertical stand-off and a portion of the first optical device comprising a common planar multiple-layer structure, the relative thickness of an upper section of the first optical device and the or each vertical stand-off being such that a second separate optical device subsequently located on the or each standoff is brought in close optical alignment with the first optical device.

2. An optical assembly according to claim 1, in which the or each stand-off is separated from the first optical device by a trench.

3. An optical assembly according to claim 1 or 2, in which the first optical device comprises at least one planar lightwave circuit.

4. An optical assembly according to claim 3, in which the first optical device is a spot size converter.

5. An optical assembly according to any preceding claim in which the substrate comprises a material selected from a group including silicon, silica-on-silicon, silicon-on-insulator, III-V semiconductor and ceramics.

6. An optical assembly according to any preceding claim, further comprising a second optical device located on the or each stand-off and in close optical alignment with the first optical device.

7. An optical assembly according to claim 6, wherein the second optical device is keyed for engagement with the or each vertical stand-off.

8. An optical assembly according to claim 6 or 7, in which the second optical device is a semiconductor laser.

9. An optical assembly comprising a plurality of optical devices and a plurality of adjacent vertical stand-offs formed on a common substrate, in accordance with any preceding claim.

10. A method for forming a first optical device and a vertical stand-off on adjacent regions of a substrate, comprising the steps:
depositing subsequent layers of optical materials on the substrate, and defining features of the optical device by masking and etching regions of at least one layer;
defining the transverse extent of the standoff by protectively masking a separate region of the or each layer that is etched;
modifying the relative thickness of an upper section of the standoff and the first optical device so that a second optical device subsequently supported by the standoff is in close optical alignment with the first optical device; and,
etching a trench through one or more layers of material between the vertical standoff and the first optical device.

11. A method according to claim 10, in which the step of modifying the relative thickness of an upper section of the standoff and the first optical device comprises recess etching an upper layer in the region that defines the standoff.

12. A method according to claim 10, in which the step of modifying the relative thickness of an upper section of the standoff and the first optical device comprises recess etching an upper layer in the region that defines the optical device.

13. A method according to claim 11 or 12, in which the step of modifying the relative thickness further comprises depositing an additional layer of material over regions defining both the vertical standoff and the first optical device.
